(19) United States
(12) Patent Application Publication
(10) Pub. No.: US 2026/0197409 A1
(43) Pub. Date: Jul. 9, 2026

(54) SHEET CONVEYING DEVICE, DOCUMENT FEEDER, AND IMAGE FORMING APPARATUS

(71) Applicant: Hiroshi KUBO, Kanagawa (JP)

(72) Inventor: Hiroshi KUBO, Kanagawa (JP)

(73) Assignee: ETRIA CO., LTD., Yokohama (JP)

(21) Appl. No.: 19/337,388

(22) Filed: Sep. 23, 2025

(30) Foreign Application Priority Data
Jan. 3, 2025 (JP) 2025-000008

(51) Int. Cl. H04N 1/00

(52) U.S. Cl. CPC H04N 1/00628; H04N 1/00588; H04N 1/00602; H04N 1/00615; H04N 1/0062

(57) ABSTRACT

A sheet conveying device includes a stacker, a pickup roller, a conveyor, a separator, a pressing member, and a pressure. The pickup roller contacts the sheet on the stacker, and conveys the sheet in a conveyance direction. The conveyor is downstream from the pickup roller in the conveyance direction, to convey the sheet. The separator contacts the conveyor to form a nip to nip the sheet, and restricts a conveyance of multiple sheets. The pressing member is upstream from the pickup roller in the conveyance direction, and switchable between a pressing state and a separated state. The pressure mechanism causes the pickup roller to apply a first pressure force to the sheet when the pressing member is in the separated state, and causes the pickup roller to apply a second pressure force to the sheet when the pressing member is in the pressing state.

### CROSS-REFERENCE TO RELATED APPLICATIONS

This patent application is based on and claims priority pursuant to 35 U.S.C. § 119(a) to Japanese Patent Application No. 2025-000008, filed on Jan. 3, 2025, in the Japan Patent Office, the entire disclosure of which is hereby incorporated by reference herein.

### BACKGROUND

### Technical Field

Embodiments of the present disclosure relate to a sheet conveying device such as a document feeder that feeds a sheet such as a document, a document feeder including the sheet conveying device, and an image forming apparatus such as a copier, a printer, a facsimile, or a multifunction peripheral or a printing machine thereof.

### Related Art

Typically, in image forming apparatuses such as copiers, printers, and printing machines, document feeders serving as sheet conveying devices that feed a document as a sheet have been widely used.

On the other hand, a document feeder discloses a technique of changing a separation pressure due to tension of a sheet feeding belt according to, for example, a thickness and a size of a document for the purpose of satisfactorily conveying a sheet regardless of a type of the sheet in an automatic document feeder (ADF).

In the typical document feeder, in a case where multiple sheets having different width direction sizes are placed on a stacker in a mixed manner, or in a case where a sheet having a small width direction size whose position in the width direction cannot be determined by a side fence is placed on the stacker, a failure such as a problem that the sheet is fed obliquely or a problem that the sheet is buckled occur.

The present disclosure has been made to solve the above-described problems, and provides a sheet conveying device, a document feeder, and an image forming apparatus that can satisfactorily feed a sheet regardless of a width direction size of the sheet placed on the placement portion.

### SUMMARY

Embodiments of the present disclosure described herein provide a novel sheet conveying device including a stacker, a pickup roller, a conveyor, a separator, a pressing member, and a pressure mechanism. The stacker stacks a sheet to be conveyed in a conveyance direction. The pickup roller contacts a surface of the sheet stacked on the stacker, and picks up the sheet in the conveyance direction. The conveyor is downstream from the pickup roller in the conveyance direction to convey the sheet picked up by the pickup roller in the conveyance direction. The separator contacts the conveyor to form a nip region to which the sheet is conveyed, and prevents multiple sheets including the sheet from being conveyed from the nip region. The pressing member is upstream from the pickup roller in the conveyance direction to switch between a pressed state in which the pressing member is pressed against the surface of the sheet stacked on the stacker and a separated state in which the pressing member is separated from the surface of the sheet stacked on the stacker. The pressurization mechanism adjusts a pressure force of the pickup roller to the sheet stacked on the stacker when the pressing member is in the pressed state, when compared with the pressing member in the separated state.

Further, embodiments of the present disclosure described herein provide a document feeder including a sheet conveying device that includes a stacker, a pickup roller, a conveyor, a separator, a pressing member, and a pressure mechanism. The stacker stacks a sheet to be conveyed in a conveyance direction. The pickup roller contacts a surface of the sheet stacked on the stacker, and picks up the sheet in the conveyance direction. The conveyor is downstream from the pickup roller in the conveyance direction to convey the sheet picked up by the pickup roller in the conveyance direction. The separator contacts the conveyor to form a nip region to which the sheet is conveyed, and prevents multiple sheets including the sheet from being conveyed from the nip region. The pressing member is upstream from the pickup roller in the conveyance direction to switch between a pressed state in which the pressing member is pressed against the surface of the sheet stacked on the stacker and a separated state in which the pressing member is separated from the surface of the sheet stacked on the stacker. The pressurization mechanism adjusts a pressure force of the pickup roller to the sheet stacked on the stacker when the pressing member is in the pressed state, when compared with the pressing member in the separated state.

Further, embodiments of the present disclosure described herein provide an image forming apparatus including a sheet conveying device that includes a stacker, a pickup roller, a conveyor, a separator, a pressing member, and a pressure mechanism. The stacker stacks a sheet to be conveyed in a conveyance direction. The pickup roller contacts a surface of the sheet stacked on the stacker, and picks up the sheet in the conveyance direction. The conveyor is downstream from the pickup roller in the conveyance direction to convey the sheet picked up by the pickup roller in the conveyance direction. The separator contacts the conveyor to form a nip region to which the sheet is conveyed, and prevents multiple sheets including the sheet from being conveyed from the nip region. The pressing member is upstream from the pickup roller in the conveyance direction to switch between a pressed state in which the pressing member is pressed against the surface of the sheet stacked on the stacker and a separated state in which the pressing member is separated from the surface of the sheet stacked on the stacker. The pressurization mechanism adjusts a pressure force of the pickup roller to the sheet stacked on the stacker when the pressing member is in the pressed state, when compared with the pressing member in the separated state.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a diagram illustrating a configuration of a document feeder;

FIG. 3 is a block diagram illustrating a control system of the document feeder;

FIG. 4 is a top view of the document feeder;

FIG. 5 is a perspective view of a pressing member of the document feeder;

FIG. 6A is a perspective view of the document feeder in a state (separated state) where the pressing member is stored at a storing position;

FIG. 6B is a perspective view of the document feeder in a state where the pressing member is pressed;

FIG. 7A is a perspective view illustrating the document feeder in a state where sheets of the same size are stacked on a document table;

FIG. 7B is a perspective view illustrating the document feeder in a state where the pressing member is rotated from the storing position to a pressing position;

FIG. 7C is a perspective view illustrating the document feeder in a state where sheets having different sizes are placed on the document table in a mixed manner;

FIGS. 8A and 8B are a top view and a side view, respectively, illustrating a state where a sheet pressed by the pressing member is conveyed in the document feeder;

FIG. 9A is a view illustrating a state where a sheet is conveyed in a state where the pressing member is stored, viewed from A indicated by arrow illustrated on a lower side;

FIG. 9B is a view illustrating a state where a sheet pressed by the pressing member is conveyed, in the document feeder, viewed from A indicated by arrow illustrated on a lower side;

FIG. 10 is a view illustrating a state where a sheet is conveyed by a document feeder as a comparative example;

FIG. 11A is a view illustrating a state where a sheet is conveyed in a state where the pressing member is stored;

FIG. 11B is a view illustrating a state where a sheet pressed by the pressing member is conveyed, in a document feeder as Modification 1; and

FIG. 12 is a view illustrating a manual sheet conveying device as Modification 2 and the vicinity of the manual sheet conveying device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

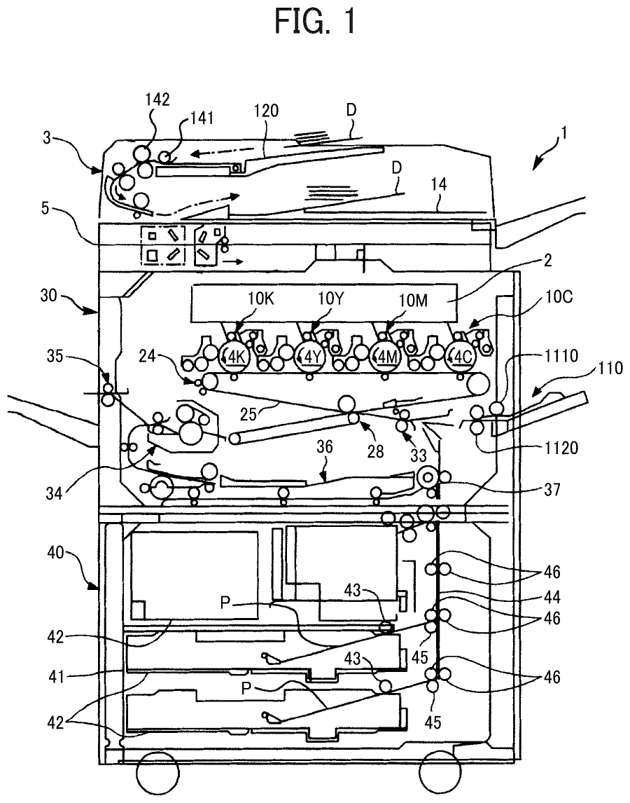

A description is given of an overall configuration and operations of an image forming apparatus 1, with reference to FIG. 1.

The image forming apparatus 1 of the present embodiment is a copier in which a document feeder 3 (ADF) as a sheet conveying device that conveys a document D and a document reading apparatus 5 (scanner) that reads image information of the document D conveyed by the document feeder 3 are installed above an image forming device 30 that forms an image on a sheet P.

A sheet feeding device 40 provided below the image forming device 30 includes two sheet feeding cassettes 42 arranged in multiple stages in a paper bank 41. The sheet feeding device 40 further includes, for example, a sending roller 43 that sends out the sheet P from the sheet feeding cassettes 42, and a separation roller 45 that separates the sent sheet P and supplies the sheet P to a conveyance path 44. The sheet feeding device 40 further includes, for example, multiple conveyance roller pairs 46 that convey the sheet P to a conveyance path 37. The sheet feeding device 40 feeds the sheet P in the sheet feeding cassettes 42 into the conveyance path 37 in the image forming apparatus 1 (image forming device 30).

The image forming apparatus 1 includes a manual sheet conveying device 110 in addition to the sheet feeding device 40.

The manual sheet conveying device 110 further includes, for example, a pickup roller 1110 that sends out the sheet P manually set by a user (operator), in other words, set after a manual sheet setting is performed by the user (operator), and a separation roller pair 1120 that separates the sent sheet P and supplies the sheet P to a registration roller pair 33.

The image forming device 30 forms an image of image information of the document D read by the document reading apparatus 5 on the sheet P (sheet P as a sheet). Due to such a configuration, the image forming device 30 further includes, for example, an optical writing apparatus 2, four process cartridges 10K, 10Y, 10M, and 10C that form toner images of four colors of black, yellow, magenta, and cyan (K, Y, M, and C), and a transfer unit 24.

The image forming device 30 further includes, for example, a sheet conveyance unit 28, the registration roller pair 33, a fixing apparatus 34, a switchback apparatus 36, and the conveyance path 37. The optical writing apparatus 2 drives a light source such as a laser diode or an LED arranged in the apparatus, and irradiates four drum-shaped photoconductor drums 4K, 4Y, 4M, and 4C with laser light. Due to this irradiation, electrostatic latent images are formed on the surfaces of the photoconductor drums 4K, 4Y, 4M, and 4C, and are to be developed to toner images via a given development process.

The image forming apparatus 1 according to the present embodiment has a so-called tandem configuration in which the four process cartridges 10K, 10Y, 10M, and 10C are arranged to face an intermediate transfer belt 25 so as to be arranged along an endless moving direction thereof.

The toner images of black, yellow, magenta, and cyan (K, Y, M, and C) are formed on the photoconductor drums 4K, 4Y, 4M, and 4C of the four process cartridges 10K, 10Y, 10M, and 10C, respectively, by a predetermined process.

The transfer unit 24 is arranged below the four process cartridges 10K, 10Y, 10M, and 10C. The transfer unit 24 endlessly moves the intermediate transfer belt 25 in the clockwise direction in the drawing while the intermediate transfer belt 25 stretched by multiple rollers is in contact with the photoconductor drums 4K, 4Y, 4M, and 4C. As a result, primary transfer nips for K, Y, M, and C are formed in which the photoconductor drums 4K, 4Y, 4M, and 4C come into contact with the intermediate transfer belt 25. In the vicinity of the primary transfer nips for K, Y, M, and C, four primary transfer rollers arranged inside the belt loop press the intermediate transfer belt 25 toward the photoconductor drums 4K, 4Y, 4M, and 4C. A primary transfer bias is applied by respective power supplies to the primary transfer rollers. As a result, a primary transfer electric field for electrostatically moving the toner images on the photoconductor drums 4K, 4Y, 4M, and 4C toward the intermediate transfer belt 25 is formed at the primary transfer nips for K, Y, M, and C. The toner images are sequentially superimposed and primarily transferred at the respective primary transfer nips on the front surface of the intermediate transfer belt 25 sequentially passing through the primary transfer nips for K, Y, M, and C along with the endless movement in the clockwise direction in the drawing. By the primary transfer of the superimposition, a four-color superimposed toner image (referred to as a four-color toner image) is formed on the front surface of the intermediate transfer belt 25.

The four-color toner image on the intermediate transfer belt 25 is collectively secondarily transferred to the sheet P, and becomes a full-color image together with the white color of the sheet P. The sheet P is separated from the intermediate transfer belt 25 and conveyed to the fixing apparatus 34 along with the endless movement.

After the full-color image is fixed by pressurization or heating in the fixing apparatus 34, the sheet P conveyed to the fixing apparatus 34 is sent from the fixing apparatus 34 to a sheet ejection roller pair 35 and then ejected to the outside of the apparatus.

The switchback apparatus 36 is arranged below the sheet conveyance unit 28 and the fixing apparatus 34. As a result, the path of the sheet P having been subjected to the image fixing treatment on the front surface (one surface) is switched to the switchback apparatus 36 side by a switching claw, and the back surface (the other surface) is also subjected to the secondary transfer treatment and the fixing treatment of the image, and then the sheet P is ejected onto a sheet ejection tray.

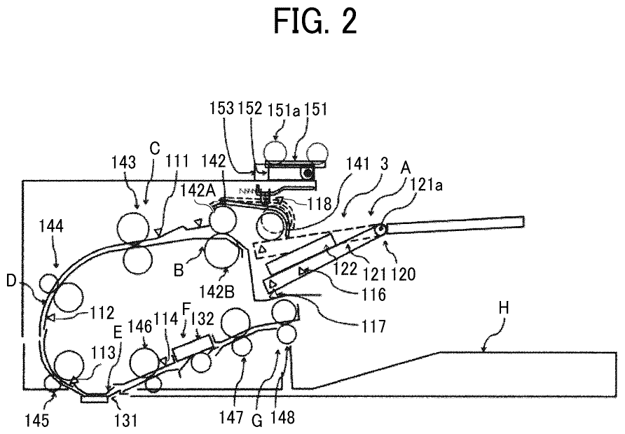

A configuration/operation of the document feeder 3 serving as a sheet conveying device is described in detail with reference to FIG. 2.

The document feeder 3 according to the present embodiment functions as a sheet conveying device that conveys the document D as a sheet in a predetermined feeding direction.

As illustrated in FIG. 2, the document feeder 3 serving as a sheet conveying device includes a document setting portion A on which the document D (including a document bundle including multiple documents D) is set, a separation feeding portion B that separates and feeds the documents D one by one from the set multiple documents D (document bundle), and a registration portion C that primarily contacts and aligns the fed documents D and draws and conveys the aligned documents.

The document feeder 3 includes a turn portion D that turns the conveyed document D and conveys the document D with the document surface facing the reading side (lower side in the drawing) by a first image reader 131.

The document feeder 3 includes a first reading conveyance portion E that reads image information on the front surface of the document D from below a contact glass of the document reading apparatus 5 by the first image reader 131, and a second reading conveyance portion F that reads an image on the back side of the document D after the image on the front surface has been read by a second image reader 132.

The document feeder 3 includes a sheet ejection portion G that ejects the document D from which the images have been read on both surfaces, to the outside of the apparatus, and a stack portion H that stacks and retains the ejected document D.

In the document setting portion A, one document or a document bundle including two or more documents (collectively referred to as “document D”) is set. The document D is set on a document table 120 as a stacker including a movable table 121.

The document feeder 3 is provided adjacent to the contact glass of the document reading apparatus 5. The document feeder 3 is configured to be openable and closable so as to open and close the contact glass via a hinge mechanism.

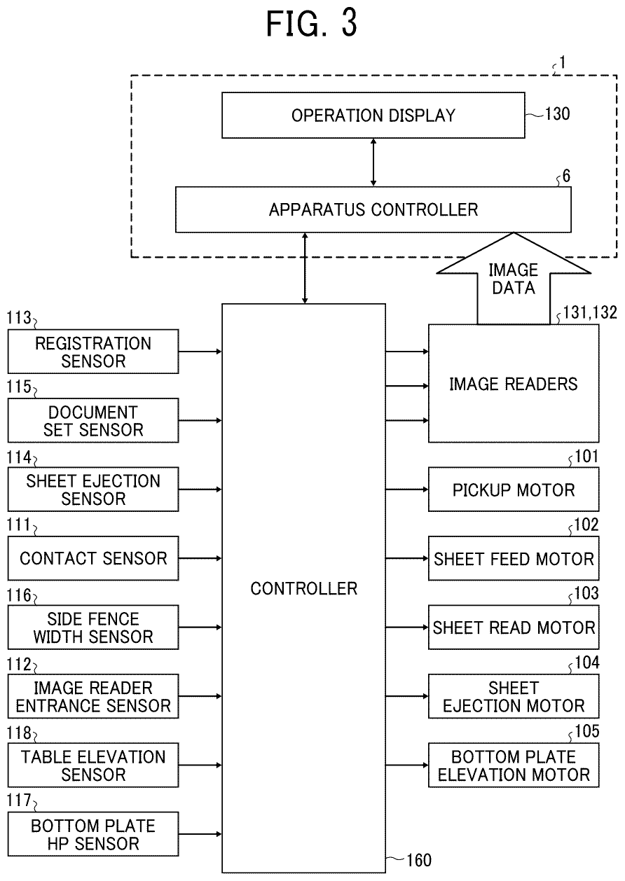

As illustrated in FIG. 3, the document feeder 3 also includes a driving mechanism including a pickup motor 101, a sheet feed motor 102, a sheet read motor 103, a sheet ejection motor 104, and a bottom plate elevation motor 105 that perform driving for a document feeding operation (document conveying operation) in each of mechanism portions A to H, a controller 160 including a circuit that controls various operations including the operation of the driving mechanism (e.g., the pickup motor 101, the sheet feed motor 102, the sheet read motor 103, the sheet ejection motor 104, and the bottom plate elevation motor 105), and various sensors including a contact sensor 111, an image reader entrance sensor 112, a registration sensor 113, a sheet ejection sensor 114, a document set sensor 115, a side fence width sensor 116, a bottom plate home position (HP) sensor 117, and a table elevation sensor 118.

The controller 160 supplies power to each portion arranged in the document feeder 3, and controls each portion arranged in the document feeder 3 on the basis of a control signal transmitted from an apparatus controller 6 provided in the main body of the image forming apparatus 1.

In the document feeder 3 (sheet conveying device) according to the present embodiment, in a case where a document image is read, the document D (including a document bundle) is set on the document table 120 (stacker) including the movable table 121 in a state where the document surface (front surface) faces upward.

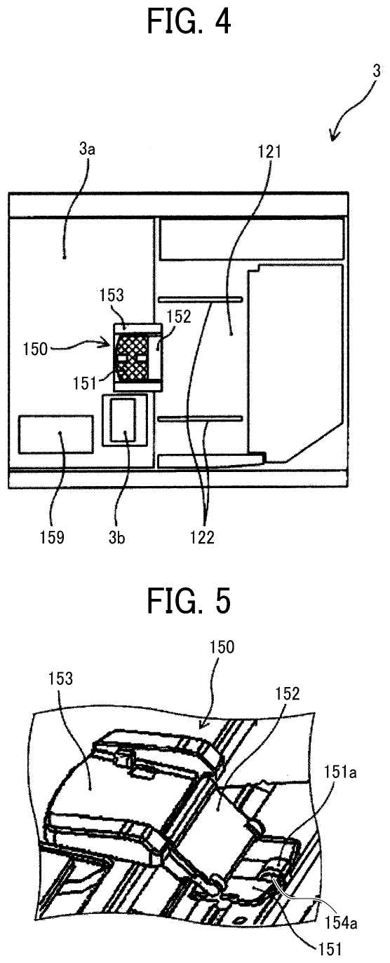

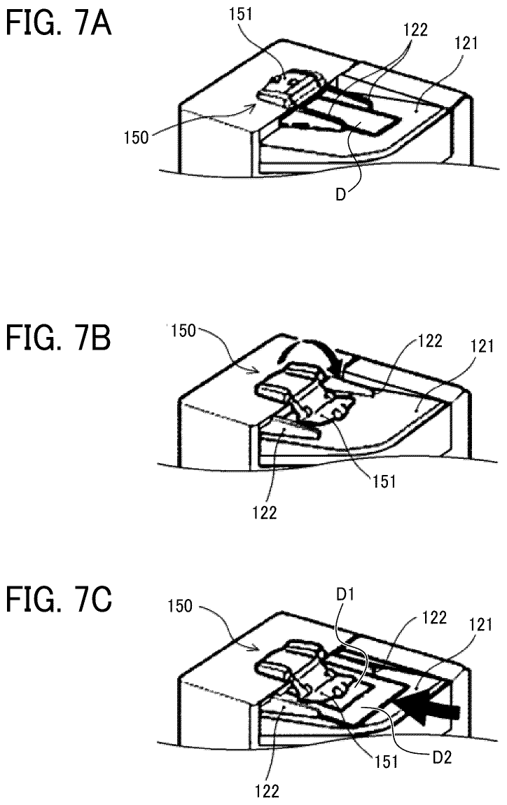

Then, the position of the document D in the width direction (a direction orthogonal to the feeding direction in which the document D is fed and a direction perpendicular to the paper surface of FIG. 2) is determined (regulated) by a pair of side fences 122 (for example, see FIGS. 4, 7A to 7C). In other words, the pair of side fences 122 is positioned (aligned) in accordance with the width direction size of the document D, which is sensed by the side fence width sensor 116. The setting of the document D (set state) is sensed by the document set sensor 115 provided on the movable table 121 and transmitted to the apparatus controller 6 via an interface (I/F).

Referring to FIG. 2, the movable table 121 is supported such that a rear end (upstream end in the feeding direction) of the movable table 121 is rotatable about a rotation shaft 121a. The movable table 121 is configured such that a front end (downstream side in the feeding direction) of the movable table 121 can be lifted and lowered by being rotated about the rotation shaft 121a by the bottom plate elevation motor 105.

Before the document D is placed on the document table 120, the movable table 121 of the document table 120 is located at the home position (lowered position). In a state where the movable table 121 is at the home position, the user places the document D on the document table 120.

At this time, the uppermost surface of the document D on the movable table 121 at the home position is in a separated state separated from a pickup roller 141.

When the document set sensor 115 senses that the document D has been set, the controller 160 causes the bottom plate elevation motor 105 to rotate forward to elevate the movable table 121. When the movable table 121 is elevated and the pickup roller 141 is pushed up by the upper surface of the document D on the movable table 121, this is sensed by the table elevation sensor 118. The controller 160 that has received this sensing signal stops the driving of the bottom plate elevation motor 105, so that the movable table 121 is stopped at an appropriate position.

In other words, the table elevation sensor 118 is a sensor that detects that the movable table 121 reaches an appropriate position and retains the upper surface of the document bundle at an appropriate feeding height. Specifically, when the table elevation sensor 118 is turned on, the raising of the movable table 121 is stopped, and then, when the upper surface position of the document D is lowered by repeating the document feeding and the table elevation sensor 118 is turned off, the movable table 121 is elevated again. When the table elevation sensor 118 is turned on again, the elevation of the movable table 121 is stopped. By repeating such a control operation, the upper surface position of the document D (the height of the uppermost document) is retained within a height range suitable for document feeding.

Instead of elevating and lowering the movable table 121, the document table 120 may be fixed and the pickup roller 141 may be elevated and lowered.

When all the documents D (document bundle) set on the document table 120 are fed, the document set sensor 115 is turned off. When the document set sensor 115 is turned off, the controller 160 reversely rotates the bottom plate elevation motor 105 to lower the movable table 121 to the home position so that the subsequent document D can be set on the document table 120. In the present embodiment, the bottom plate HP sensor 117 that senses that the movable table 121 is at the home position is provided, and the controller 160 can confirm whether the movable table 121 is at the home position.

When a document reading instruction operation (feeding start instruction) is performed on an operation display 130 in a state where the uppermost surface of the document D on the movable table 121 and the pickup roller 141 are in contact with each other, a document feeding signal (feeding start signal) is transmitted from the apparatus controller 6 to the controller 160 via the interface. As a result, the feeding operation is started, and in a state where the upper surface of the document D on the movable table 121 is maintained at an appropriate feeding height, the pickup roller 141 is rotationally driven by the forward rotation of the sheet feed motor 102, and several (ideally, one) documents D on the document table 120 are picked up and conveyed. The rotation direction at this time is a direction in which the uppermost document D is conveyed forward in the feeding direction.

A separation roller pair 142 includes a feeding roller 142A as a conveyor and a reverse roller 142B that contacts on the feeding roller 142A to form a nip. The feeding roller 142A is rotationally driven in the feeding direction by the forward rotation of the sheet feed motor 102, and the reverse roller 142B is rotationally driven in the direction opposite to the feeding direction by the forward rotation of the sheet feed motor 102.

The document D separated into one by the separation roller pair 142 is further conveyed by the feeding roller 142A, and after the leading end is sensed by the contact sensor 111, the document D further advances and contacts a pullout roller pair 143 that is stopped.

Then, the document D is conveyed a predetermined distance from the sensing timing of the contact sensor 111, so that the leading end is pressed against the pullout roller pair 143 with a predetermined amount of deflection. In this state, by stopping the sheet feed motor 102, the driving of the feeding roller 142A that conveys the document D is stopped.

When the leading end of the document D is sensed by the contact sensor 111, the controller 160 rotates the pickup motor 101 to retract the pickup roller 141 from the upper surface of the document D. Therefore, the document D is conveyed by the conveying force of the feeding roller 142A of the separation roller pair 142. Due to such an operation, the leading end of the document D enters the nip portion of the pullout roller pair 143 to align the leading end (skew correction). The pullout roller pair 143 is a roller that has a skew correction function and conveys the document D subjected to skew correction after separation to an intermediate roller 144, and is driven by reverse rotation of the sheet feed motor 102. At the time of reverse rotation of the sheet feed motor 102, the pullout roller pair 143 and the intermediate roller 144 are driven, but the pickup roller 141 and the feeding roller 142A are not driven.

The length of the document D in the conveyance direction is configured to be detected from the motor pulse by sensing the leading end and the trailing end of the document D with the contact sensor 111. The document D is conveyed from the registration portion C to the turn portion D by driving of the pullout roller pair 143 and the intermediate roller 144. At this time, the conveyance speed in the registration portion C is set to be higher than the conveyance speed in the first reading conveyance portion E. Accordingly, the processing time for feeding the document D to the first reading conveyance portion E can be reduced. When the leading end of the document D is detected by the image reader entrance sensor 112, deceleration is started in order to make the document conveyance speed the same as the reading conveyance speed before the leading end of the document D enters the nip portion of a reading entrance roller pair 145. At the same time, the sheet read motor 103 is driven to rotate forward to drive the reading entrance roller pair 145, a first reading outlet roller 146, and a second reading outlet roller 147.

When the leading edge of the document D is sensed by the registration sensor 113, the controller 160 temporarily stops the document D before the first reading conveyance portion E and transmits a temporary stop signal to the apparatus controller 6 via the interface. Then, in response to receiving a reading start signal from the apparatus controller 6, the controller 160 causes the temporarily stopped document D to be conveyed at an increased speed so as to rise to a predetermined conveyance speed before the leading end of the document D reaches the first reading conveyance portion E. The controller 160 transmits a gate signal indicating a sub-scanning direction effective image region of a first surface to the first image reader 131 at a timing when the leading end of the document D detected by the pulse count of the sheet read motor 103 reaches the first reading conveyance portion E. The gate signal is transmitted until the trailing end of the document D passes through the first reading conveyance portion E.

In the case of single-sided document reading, the document D that has passed through the first reading conveyance portion E passes through the second reading conveyance portion F so as to be conveyed to the sheet ejection portion G. At this time, when the sheet ejection sensor 114 senses the leading end of the document D, the controller 160 drives the sheet ejection motor 104 to rotate forward to rotate a sheet ejection roller pair 148.

The controller 160 counts pulses of the sheet ejection motor 104 after the leading end of the document D is sensed by the sheet ejection sensor 114. Then, control is performed so that the driving speed of the sheet ejection motor 104 is decelerated immediately before the trailing end of the document D passes through the nip portion of the sheet ejection roller pair 148, and the document D ejected onto the sheet ejection tray of the stack portion H does not jump out.

In the case of double-sided document reading, the controller 160 senses the leading end of the document D that has passed through the first reading conveyance portion E with the sheet ejection sensor 114, and then counts the pulses of the sheet read motor 103. Then, the controller 160 transmits a gate signal indicating an effective image region in the sub-scanning direction to the second image reader 132 at a timing when the leading end of the document D reaches the second reading conveyance portion F. The gate signal is transmitted until the trailing end of the document D passes through the second reading conveyance portion F. Then, the document D that has passed through the second reading conveyance portion F is conveyed to the sheet ejection portion G.

A detailed description is given of the configuration and operations of the document feeder 3 as a sheet conveying device in the present embodiment.

As described above with reference to FIG. 2, for example, in the document feeder 3 as a sheet conveying device according to the present embodiment, the document table 120 as a placement portion on which the document D (including the document bundle) as the sheet P can be placed, the pickup roller 141, the feeding roller 142A, and the reverse roller 142B as a separation member, the pair of side fences 122 are installed.

The pickup roller 141 contacts on a front surface (upper surface) of the document D (sheet) placed on the document table 120 (stacker) and conveys the document D in the feeding direction.

The feeding roller 142A is installed on the downstream side in the feeding direction with respect to the pickup roller 141, and conveys the document D (sheet) conveyed by the pickup roller 141 in the feeding direction.

The reverse roller 142B contacts on the feeding roller 142A to form a nip in which the document D (sheet) is conveyed. The reverse roller 142B functions as a separation member for preventing multiple documents D (sheets) from being sent out (multifeeding) from the nip with the feeding roller 142A, and constitutes the separation roller pair 142 together with the feeding roller 142A.

The pair of side fences 122 is members for determining (regulating) a position in the width direction (direction orthogonal to the feeding direction) with respect to the document D (sheet) placed on the document table 120 (stacker).

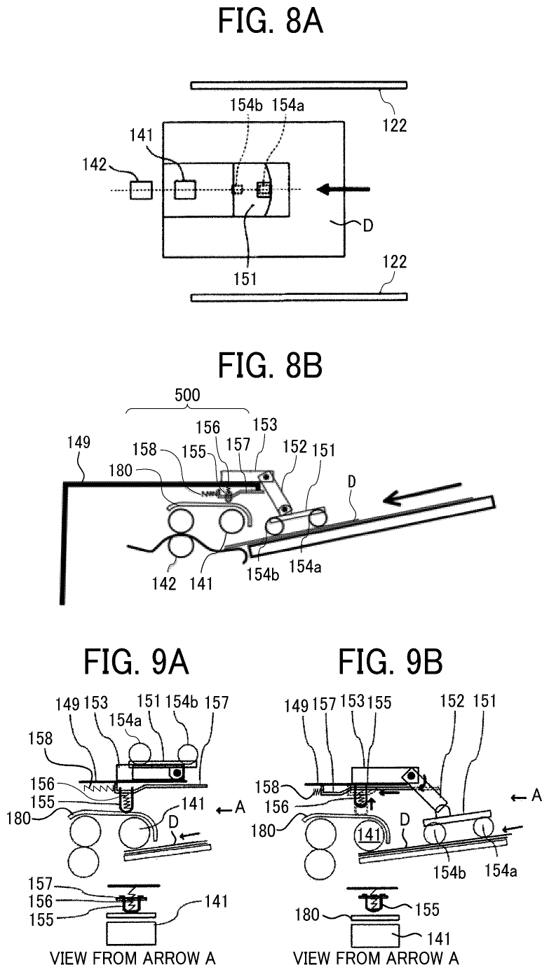

Referring to FIGS. 2, 4 to 9B, for example, the document feeder 3 (sheet conveying device) according to the present embodiment is provided with a holding mechanism 150 in which pressing rollers 154a and 154b as pressing members are installed, and a pressurization mechanism 500 (see FIG. 8B) including a pressure pin 155, a first compression spring 158, a second compression spring 156, and a slide member 157. The pressurization mechanism 500 can adjust the pressurization force of the pickup roller 141 to the document D on the document table 120.

The pressing rollers 154a and 154b as pressing members are installed on the upstream side in the feeding direction with respect to the pickup roller 141. Then, the pressing rollers 154a and 154b (each as a pressing member) are configured to be switchable between a pressed state (for example, the states in FIGS. 7C, 8A, 8B, and 9B) in which the pressing rollers are pressed against the front surface (upper surface) of the document D (sheet) placed on the document table 120 (stacker) and a separated state (for example, the states in FIGS. 2, 7A, and 9A) in which the pressing rollers are separated from the front surface.

Specifically, referring to FIG. 8A, for example, the pressing rollers 154a and 154b (each as a pressing member) are arranged at the center in the width direction, and rotate together as a result of the conveyance of the document D (sheet) to be pressed in the feeding direction in the pressed state. In the present embodiment, the multiple pressing rollers 154a and 154b (two pressing rollers) is installed at an interval in the feeding direction.

Then, when the document D (sheet) whose position in the width direction cannot be determined by the pair of side fences 122 is placed on the document table 120 (stacker), the pressing rollers 154a and 154b (each as a pressing member) are manually brought into the pressed state by the operator such as the user.

As illustrated in FIG. 9C, multiple documents D1 and D2 (sheets) having different width direction sizes may be placed on the document table 120 (stacker) in a mixed manner. The multiple documents D1 and D2 have different width direction sizes. In a case where the multiple documents D1 and D2 having different width direction sizes is placed on the document table 120 in the mixed manner, the positions in the width direction of the pair of side fences 122 are determined in accordance with the document D2 having the largest width direction size. Therefore, the document D1 having a smaller width direction size is not determined in the posture in the width direction by the side fences 122, and is easily fed in an oblique (skewed) manner. However, since the pressing rollers 154a and 154b (each as a pressing member) press the document D1 having a smaller size from above, the width direction position is determined so that the conveyance reference center position matches with the width direction center position of the document D, and the oblique force is reduced, so that the document can be easily fed straight and stably in the feeding direction.

Although not illustrated, even in a case where a movable range in the width direction of the pair of side fences 122 is determined and a document D having a width direction size smaller than the smallest width direction size in the movable range is set on the document table 120, the posture in the width direction is not determined by the side fences 122. However, since the pressing rollers 154a and 154b press such a small-sized document D from above, the width direction position is determined so that a conveyance reference center position matches with a width direction center position of the document D, and the document D can be stably fed straight in the feeding direction without skew.

In particular, in the present embodiment, since the multiple pressing rollers 154a and 154b is arranged side by side at an interval in the feeding direction, the small-sized document D is fed in a balanced manner without skew.

On the other hand, when the document D (sheet) whose position in the width direction cannot be determined by the pair of side fences 122 is not placed on the document table 120 (stacker) (when the document D that can be regulated by the side fences 122 is stacked), the pressing rollers 154a and 154b (each as a pressing member) are manually brought into the separated state (for example, the states in FIGS. 2, 4, 6A, 7A, and 9A) by the operator such as the user.

In such a case, the documents D having the same width direction size that falls within the movable range of the pair of side fences 122 are set on the document table 120. The width direction position of such a document D is determined by the pair of side fences 122 such that the conveyance reference center position matches with the width direction center position of the document D, and the document D is stably fed straight in the feeding direction without skew.

In the present embodiment, when the pressing rollers 154a and 154b (each as a pressing member) are in the separated state, the pressing rollers are stored at the storing position (for example, the positions illustrated in FIGS. 2, 4, 6A, 7A, and 9A) that do not hinder the setting of the document D (sheet) on the document table 120 (stacker) by the operator.

The pressurization mechanism 500 including the pressure pin 155, the first compression spring 158 as a biasing member, the second compression spring 156, and the slide member 157 installed in the document feeder 3 perform adjustment such that the pressurization force of the pickup roller 141 with respect to the document D (sheet) placed on the document table 120 (stacker) is reduced when the pressing rollers 154a and 154b (each as a pressing member) are in the pressed state as compared to when the pressing rollers are in the separated state, which will be described below in detail with reference to FIGS. 9A and 9B, for example.

The holding mechanism 150 in which the pressing rollers 154a and 154b, each as a pressing member, are installed will be described in detail.

As illustrated in FIG. 4, the holding mechanism 150 is provided at the center in the width direction of the upstream end in the feeding direction (left-right direction in FIG. 4) of the upper surface of an outer cover 3a of the document feeder 3. An operation lever 3b for opening the outer cover 3a is located on the front side of the apparatus (the side on which the operator faces the apparatus) with respect to the holding mechanism 150. As a result, the operator (user) can operate the operation lever 3b without the holding mechanism 150 interfering with the operation of the operation lever 3b.

FIG. 5 illustrates a holding plate 151 of the holding mechanism 150 in use (the pressed state of the pressing rollers 154a and 154b).

As illustrated in FIG. 5, the holding mechanism 150 includes the holding plate 151 as a pressing member, an arm member 152, and a storage member 153. The arm member 152 rotatably supports the holding plate 151 and is rotatably supported by the storage member 153.

The inclination angle of the movable table 121 of the document table 120 is different between when the document is set and when the document is fed. By rotatably supporting the holding plate 151 on the arm member 152, the holding plate 151 can follow the change in the inclination angle of the movable table 121. By rotatably supporting the holding plate 151 on the arm member 152, the holding plate 151 can be stored in the storage member 153 so as to be folded on the arm member 152. As a result, the holding mechanism 150 when the holding plate 151 is not used can be made compact.

In the holding plate 151, the pressing rollers 154a and 154b (for example, see FIGS. 8A and 8B) as pressing members are rotatably supported at a central portion in the width direction. At the center in the width direction on the upstream side in the feeding direction of the holding plate 151, a cover portion 151a having a protrusion shape that covers the pressing roller 154a rotatably supported on the upstream side in the feeding direction is provided. In the present embodiment, the cover portion 151a having a protrusion shape functions as a mark for aligning the center of the document D in the width direction with the conveyance reference position.

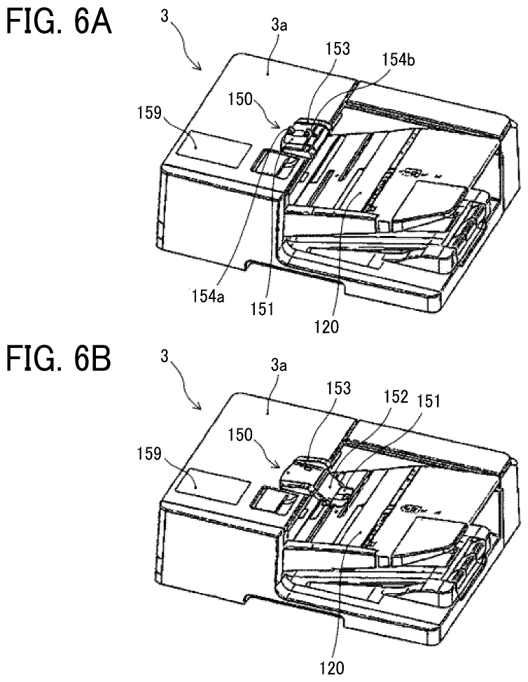

As illustrated in FIG. 6A, when the holding plate 151 (the pressing rollers 154a and 154b) is not used, the arm member 152 and the holding plate 151 are stored in the storage member 153 so as to be folded over the storage member 153. The holding plate 151 is stored in the storage member 153 (in the separated state) such that the surface facing the placement surface of the document table 120 is the upper surface in use.

As described above, when the holding plate 151 is not used, the holding plate 151 is located at the storing position (second position) retracted from the position close to the document D on the document table 120 on the outer cover 3a, and thus, the holding plate 151 can be prevented from becoming an obstacle at the time of setting the document.

On the other hand, when the holding plate 151 (the pressing rollers 154a and 154b) is used, the holding plate 151 stored in the storage member 153 is lifted and rotated approximately 180 degrees to be deployed. Then, as illustrated in FIG. 6B, the pressing rollers 154a and 154b of the holding plate 151 are brought into contact with the placement surface of the document table 120. As a result, the holding plate 151 is located at a use position (first position) close to the document D on the document table 120 (the pressed state). When the holding plate 151 is moved from the storing position to the use position in this manner, the arm member 152 that rotates accordingly pushes the slide member 157 to be described below and the slide member 157 slides and moves to reduce the pressurization force of the pickup roller 141, which will be described in detail below.

An indication label 159 as an instruction device for instructing how to use the holding plate 151 is attached to the upper surface of the outer cover 3a. The indication label 159 includes a description for prompting positioning of the holding plate 151 at the use position (the pressed state) illustrated in FIG. 6B when setting the mixed document bundle on the document table 120. This indication label 159 includes a description for prompting setting of the document D such that the center of the holding plate 151 in the width direction is aligned with the center of the document D in the width direction by using the holding portion (cover portion 151a) of the holding plate 151 as a holder.

As illustrated in FIG. 7A, when the user (operator) sets the documents D (document bundle) having the same width direction size on the document table 120, the width direction ends of the documents D are regulated by the side fences 122, so that the center of the documents D in the width direction can be aligned with the conveyance reference position, which is a desired position. Therefore, at this time, the holding plate 151 is unnecessary, and is stored in the storage member 153 and retracted from the document table 120. As a result, when the document D is set on the document table 120, the document D can be easily set on the document table 120 without the holding plate 151 being an obstacle.

On the other hand, as illustrated in FIG. 7B, when the user sets the document bundle including multiple documents D having different width direction sizes in a mixed manner, the holding plate 151 is moved from the storing position where the holding plate 151 is stored in the storage member 153 to the use position close to the document table 120.

When the holding plate 151 is located at the use position, as illustrated in FIG. 7C, the documents D are sequentially inserted between the holding plate 151 and the document table 120 from the upstream side in the feeding direction from the lowermost document D of the mixed document bundle as illustrated by the arrow in the drawing. At this time, the pressing rollers 154a and 154b rotatably supported by the holding plate 151 rotate together with the inserted document D, and the document D can be smoothly inserted between the holding plate 151 and the document table 120.

Referring to FIGS. 8A and 8B, the user inserts the document D between the holding plate 151 and the document table 120 from the upstream side in the feeding direction (insertion in the arrow direction in the drawing). After the document is inserted, the document D is moved in the width direction so that the center in the width direction of the cover portion 151a and the center in the width direction of the document D match with each other and the amounts of protrusion of the document D from both ends in the width direction of the holding plate 151 are the same, thereby aligning the document D. As a result, the center of the document D in the width direction can be aligned with the conveyance reference position indicated by the broken line in FIG. 8A. Then, when the alignment of the document D is completed, the user inserts the subsequent document D between the holding plate 151 and the document table 120 from the upstream side in the feeding direction.

In this manner, the user can set the document bundle including documents D having different width direction sizes in a mixed manner (appropriately referred to as a “mixed document bundle”).

Then, when all the documents D of the mixed document bundle are inserted between the holding plate 151 and the document table 120, the user moves the side fences 122 in the width direction to contact width direction ends of the document D2 having the largest width direction size among the documents of the mixed document bundle. Accordingly, setting of the mixed document bundle is completed. When the setting of the mixed document bundle is completed, the user operates the operation display 130 to start the conveyance of the documents D in a “mixed mode”.

When the feeding of the documents D is started in the “mixed mode”, the documents D are fed at a slower feeding speed than in a “normal mode” set when the document bundle having the same width in the width direction size (document width) described above with reference to FIG. 7A is set.

The document D1 other than the document D2 having the largest width direction size within the mixed document bundle is not regulated in the width direction by the side fences 122. Therefore, the document D1 other than the largest document D2 on the document table 120 moves along with the movement of the document D being fed in the width direction, and the posture of the document D1 may gradually be lost.

Therefore, when the document D is fed at the feeding speed in the normal mode, the kinetic energy is large, the force exerted on the document D before being fed on the document table 120 by the document D being fed becomes strong, and the possibility that the document D before being fed on the document table 120 moves increases.

As in the present embodiment, by making the feeding speed in the mixed mode slower than the feeding speed in the normal mode, the force exerted on the document D can be reduced before being fed on the document table 120 by the document D being fed. As a result, the loss of the posture of the document D1 other than the largest document D2 on the document table 120 can be reduced, and the occurrence of feeding failure can be reduced.

The document D1 other than a document having the maximum width within the mixed document bundle is fed without being regulated in the width direction by the side fences 122, so that skew is likely to occur. However, in the present embodiment, the pressing rollers 154a and 154b of the holding plate 151 press and feed the document. Accordingly, skew (oblique movement) of the document D1 at the time of feeding because of the pressing by the pressing rollers 154a and 154b can be reduced.

In particular, referring to FIG. 8A, for example, in the present embodiment, the pressing rollers 154a and 154b (each as a pressing member) are arranged at the center in the width direction, and are arranged such that the center positions in the width direction substantially match with the center positions in the width direction of the pickup roller 141 and the separation roller pair 142 (the feeding roller 142A (conveyor) and the reverse roller 142B (separator)).

In other words, the centers of the pressing rollers 154a and 154b in the width direction are located at the conveyance reference position, and are arranged side by side on a straight line in the feeding direction with the pickup roller 141 and the separation roller pair 142.

As a result, application of the force in the width direction to the document D at the time of feeding is suppressed, and occurrence of skew can be satisfactorily reduced with respect to the document D1 that is not regulated by the side fences 122.

As described above, since the pressing rollers 154a and 154b are configured to rotate together with the document D to be fed instead of being rotated by actively receiving the driving force from a driving source, there is almost no sliding resistance at the time of feeding the document D, and the damage to the document D is also reduced.

Referring to FIGS. 9A and 9B, for example, the document feeder 3 as the sheet conveying device in the present embodiment is provided with the pressurization mechanism 500 including the pressure pin 155, the first compression spring 158, the second compression spring 156, and the slide member 157 that adjust the pressurization force of the pickup roller 141 with respect to the document D (sheet) placed on the document table 120 (stacker) to be reduced when the pressing rollers 154a and 154b (each as a pressing member) are in the pressed state as compared with the case where the pressing rollers 154a and 154b are in the separated state.

Specifically, the pressurization mechanism 500 including the pressure pin 155, the first compression spring 158, the second compression spring 156, and the slide member 157 reduce the pressurization force of the pickup roller 141 described above in conjunction with the operation in which the pressing rollers 154a and 154b (each as a pressing member) are switched from the separated state illustrated in FIG. 9A to the pressed state illustrated in FIG. 9B. On the other hand, the pressurization mechanism 500 including the pressure pin 155, the first compression spring 158, the second compression spring 156, and the slide member 157 increase the pressurization force of the pickup roller 141 described above in conjunction with the operation in which the pressing rollers 154a and 154b are switched from the pressed state illustrated in FIG. 9B to the separated state illustrated in FIG. 9A.

More specifically, the pressurization mechanism includes the pressure pin 155 as a pressurizing member that indirectly pressurizes the pickup roller 141 from above via a retention member 180, the slide member 157 that slidingly moves to change the position of the pressure pin 155 in a vertical direction, a first compression spring 158 as a biasing member that biases the slide member 157 in a positive direction (the right side in FIGS. 9A and 9B) in a sliding direction, the second compression spring 156 that biases the pressure pin 155 downward with respect to the slide member 157, for example. The retention member 180 is configured to rotatably retain each of the pickup roller 141 and the feeding roller 142A as a conveyor (or the separation roller pair 142).

Then, in conjunction with the operation in which the pressing rollers 154a and 154b (each as a pressing member) are switched from the separated state to the pressed state, the slide member 157 slides in the opposite direction (left side in FIGS. 9A and 9B) with respect to the positive direction so that the pressure pin 155 moves upward against the biasing force of the first compression spring 158 (biasing member), and the pressurization force of the pickup roller 141 is reduced. The slide member 157 is formed with a guide for guiding the upward movement of the pressure pin 155 as described above against the biasing force of the second compression spring 156. Such sliding movement of the slide member 157 in the opposite direction occurs when the slide member 157 is pushed by the arm member 152 that rotates when the holding plate 151 is moved from the storing position to the use position.

On the other hand, in conjunction with the operation in which the pressing rollers 154a and 154b (each as a pressing member) are switched from the pressed state to the separated state, the slide member 157 slides in the positive direction (right side in FIGS. 9A and 9B) so that the pressure pin 155 moves downward by the biasing force of the first compression spring 158 (biasing member), and the pressurization force of the pickup roller 141 is increased. The guide of the slide member 157 described above is formed such that the pressure pin 155 is moved downward by the biasing force of the second compression spring 156 when the slide member 157 moves in the positive direction. Such sliding movement of the slide member 157 in the positive direction occurs when the arm member 152 retracts from the position of pushing the slide member 157 (the pushing is released) when the holding plate 151 is moved from the use position to the storing position.

As described above, in the present embodiment, the pressurization force of the pickup roller 141 is reduced at the time of using the holding plate 151 (at the time of the pressed state) as compared with the normal time (at the time of the separated state in which the holding plate 151 is stored). Therefore, even when the document D having a small width direction size whose position in the width direction cannot be determined by the side fences 122 is fed, the document D can be satisfactorily fed without causing a failure such as buckling of the document D. Even at the time of such pressure reduction, the conveying force of the pickup roller 141 is set to be larger than the load of pulling out the document D from the pressing rollers 154a and 154b.

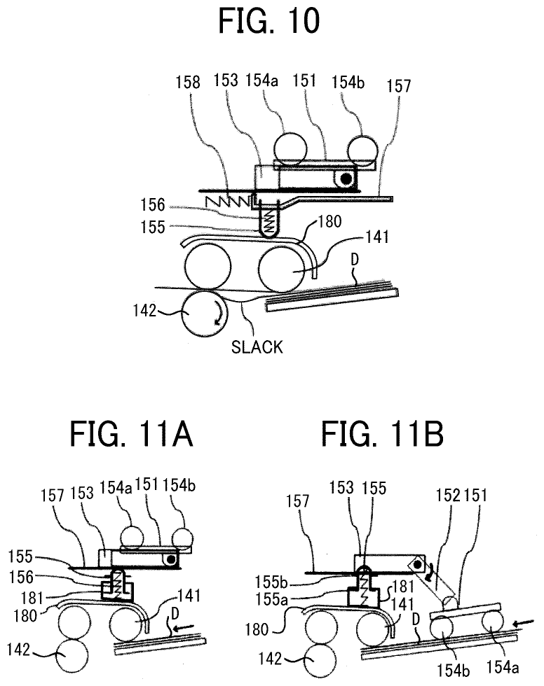

The reason why such a configuration is adopted is that, when the pressurization force of the pickup roller 141 is not reduced and remains in the normal state at the time of use (at the time of the pressed state) of the holding plate 151, as illustrated in FIG. 10 as a comparative example, a phenomenon in which the subsequent document D to be fed following in the document D fed first advances to the position of the separation roller pair 142 and is returned by the reverse roller 142B to be bent easily occurs. In particular, such a phenomenon is likely to occur when a document D having a high friction coefficient, a small size, and a light weight such as a slip is fed, or when a thin document D or a document D having a narrow width direction size is fed, and when such bending occurs, damage is likely to occur in the document D.

On the other hand, in the present embodiment, as illustrated in FIG. 9B, at the time of using the holding plate 151 (at the time of the pressed state), the pressurization force by the pickup roller 141 is reduced as compared with the normal time (at the time of the separated state), and thus, the subsequent document D to be fed following the document D fed first is less likely to advance to the position of the separation roller pair 142. Therefore, the phenomenon that the document D is bent as described with reference to FIG. 10 is less likely to occur. Therefore, the document D can be satisfactorily fed regardless of the width direction size of the document D placed on the document table 120.

In the present embodiment, the pressurizing mechanism 500 including the pressure pin 155 as a pressurizing member, the first compression spring 158, the second compression spring 156, and the slide member 157 pressurizes a side (right side in FIGS. 9A and 9B) of the retention member 180 closer to the pickup roller 141 than to the feeding roller 142A.

As a result, the responsiveness of the increase or decrease in the pressurization force of the pickup roller 141 described above can be enhanced as compared with the case where the side (the left side in FIGS. 9A and 9B) far from the pickup roller 141 is pressurized.

In the present embodiment, the pressure pin 155 is to indirectly pressurize the pickup roller 141 from above via the retention member 180, but the pressure pin 155 may be configured to directly pressurize the pickup roller 141 from above.

In the present embodiment, the relation of A≤B≤C is satisfied, where “A” represents a conveyance load applied to the document D (sheet) by the pressing rollers 154a and 154b (each as a pressing member) in the pressed state, “B” represents a conveyance force when the pickup roller 141 conveys the document D when the pressing rollers 154a and 154b are in the pressed state, and “C” represents a conveyance force when the pickup roller 141 conveys the document D when the pressing rollers 154a and 154b are in the separated state. In this manner, the conveyance load of the pressing rollers 154a and 154b is set to be smaller than the conveying force at the time of pressure reduction or normal time of the pickup roller 141, so that the non-feeding of the document D hardly occurs.

### Modification 1

As illustrated in FIGS. 11A and 11B, the document feeder 3 (the sheet conveying device) according to Modification 1 is different from the document feeder of FIGS. 9A and 9B in the configuration of the pressurization mechanism that adjusts the pressurization force of the pickup roller 141.

As illustrated in FIGS. 11A and 11B, in the pressurization mechanism of Modification 1, a pressurization portion retention member 181 that retains the pressure pin 155 is integrally provided on the retention member 180 that retains the pickup roller 141 (separation roller pair 142). Inside the pressurization portion retention member 181, the pressure pin 155 biased upward by the second compression spring 156 is installed so as to be movable up and down. A leading end portion 155b (upper portion) of the pressure pin 155 protrudes from a hole portion formed in a ceiling portion of the pressurization portion retention member 181 and contacts on the guide formed in the slide member 157. Although not illustrated, the slide member 157 is biased to the right in FIGS. 11A and 11B by the first compression spring 158 (biasing member) similarly to the slide member 157 in FIGS. 9A and 9B.

Also in Modification 1, as illustrated in FIG. 11B, in conjunction with the operation in which the pressing rollers 154a and 154b (each as a pressing member) are switched from the separated state to the pressed state, the slide member 157 slides in the opposite direction (left side in FIGS. 11A and 11B) with respect to the positive direction so that the pressure pin 155 moves upward against the biasing force of the compression spring (biasing member), and the pressurization force of the pickup roller 141 is reduced. The slide member 157 is formed with a guide for guiding the upward movement of the pressure pin 155 as described above by the biasing force of the second compression spring 156. Such sliding movement of the slide member 157 in the opposite direction occurs when the slide member 157 is pushed by the arm member 152 that rotates when the holding plate 151 is moved from the storing position to the use position.

On the other hand, as illustrated in FIG. 11A, in conjunction with the operation in which the pressing rollers 154a and 154b (each as a pressing member) are switched from the pressed state to the separated state, the slide member 157 slides in the positive direction (the right side in FIGS. 9A and 9B) so that the pressure pin 155 moves downward by the biasing force of the compression spring (biasing member), and the pressurization force of the pickup roller 141 is increased.

The guide of the slide member 157 described above is formed such that when the slide member 157 moves in the positive direction, the pressure pin 155 moves downward against the biasing force of the second compression spring 156. Such sliding movement of the slide member 157 in the positive direction occurs when the arm member 152 retracts from the position of pushing the slide member 157 (the pushing is released) when the holding plate 151 is moved from the use position to the storing position.

Even in a case where the pressurization mechanism is configured in this manner, the document D can be satisfactorily fed regardless of the width direction size of the document D (sheet) placed on the document table 120 (stacker).

### Modification 2

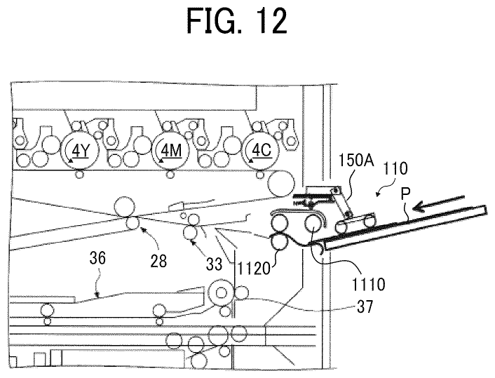

As illustrated in FIG. 12, in the manual sheet conveying device 110 as a sheet conveying device installed in the image forming apparatus 1 according to Modification 2, the characteristic configuration/operation of the present invention in the document feeder 3 as a sheet conveying device described with reference to FIGS. 2 to 9B, for example, are applied.

In other words, the manual sheet conveying device 110 of Modification 2 is a sheet conveying device that feeds the sheet P as a sheet in a predetermined feeding direction, and includes the document placement portion (manual sheet feeding tray) on which the sheet P can be placed, and a pickup roller 1110 that contacts on the surface of the sheet P placed on the placement portion and conveys the sheet P in the feeding direction. A separation roller pair 1120 including a feed roller that conveys the sheet P conveyed by the pickup roller 1110 in the feeding direction and a reverse roller as a separation member is provided on the downstream side in the feeding direction. Then, the holding mechanism 150 including the pressing rollers 154a and 154b (each as a pressing member) that can switch between the pressed state and the separated state with respect to the surface of the sheet P placed on the placement portion is installed on the upstream side in the feeding direction with respect to the pickup roller 1110. There are provided the pressurization mechanism 500 including the pressure pin 155, the first compression spring 158, the second compression spring 156, and the slide member 157 that perform adjustment such that the pressurization force of the pickup roller 1110 with respect to the document D placed on the placement portion is reduced when the pressing rollers 154a and 154b are in the pressed state as compared with when the pressing rollers 154a and 154b are in the separated state.

By configuring the manual sheet conveying device 110 in this manner, the sheet P can be satisfactorily fed regardless of the width direction size of the sheet P (sheet) placed on the placement portion.

As described above, the document feeder 3 according to the present embodiment is the sheet conveying device that feeds the document D (sheet) in a predetermined feeding direction, and includes the document table 120 (stacker) on which the document D can be placed, and the pickup roller 141 that contacts on the surface of the document D placed on the document table 120 to convey the document D in the feeding direction. The feeding roller 142A that conveys the document D conveyed by the pickup roller 141 in the feeding direction is installed on the downstream side in the feeding direction with respect to the pickup roller 141. There is provided the reverse roller 142B (separation member) for forming a nip that contacts on the feeding roller 142A and conveys the document D so that multiple documents D is not sent out from the nip. Then, the pressing rollers 154a and 154b (each as a pressing member) that can switch between the pressed state and the separated state with respect to the surface of the document D placed on the document table 120 are installed on the upstream side in the feeding direction with respect to the pickup roller 141. There are provided the pressurization mechanism 500 including the pressure pin 155, the first compression spring 158, the second compression spring 156, and the slide member 157 that perform adjustment such that the pressurization force of the pickup roller 141 with respect to the document D placed on the document table 120 is reduced when the pressing rollers 154a and 154b are in the pressed state as compared with when the pressing rollers 154a and 154b are in the separated state.

As a result, the document D can be satisfactorily fed regardless of the width direction size of the document D (sheet) placed on the document table 120 (stacker).

In the present embodiment, the present invention is applied to the document feeder 3 installed in the color image forming apparatus 1. However, the present invention can of course be applied to a document feeder installed in a monochrome image forming apparatus.

In the present embodiment, the present invention is applied to the document feeder 3 installed in the image forming apparatus 1 of an electrophotographic system is installed. However, the application of the present invention is not limited to this, and the present invention can also be applied to a document feeder installed in an image forming system of another system (for example, an image forming apparatus of an inkjet system or a stencil printing machine).

In the present embodiment, the operator manually switches between the pressed state and the separated state of the pressing rollers 154a and 154b (each as a pressing member). However, a switching mechanism that automatically switches between the pressed state and the separated state of the pressing rollers 154a and 154b (each as a pressing member) may be driven and controlled on the basis of a sensing result of sensing the size of the document D.

In the present embodiment, the reverse roller 142B is used as the separation member, but the separation member is not limited thereto, and for example, a separate pad can also be used as the separation member.

In the present embodiment, the two pressing rollers 154a and 154b are used as the pressing members, but one or three or more pressing rollers can be used as the pressing member, and a belt-shaped member, or a plate-shaped member, for example, can also be used as the pressing member.

Even in such a case, an effect similar to that of the present embodiment can be obtained.

In the present embodiment, the pickup roller 141 and the pressing rollers 154a and 154b (each as a pressing member) are configured to contact on the upper surface of the document D (sheet) placed on the document table 120 (stacker), but the pickup roller 141 and the pressing rollers 154a and 154b (each as a pressing member) may be configured to contact on the lower surface of the document D (sheet). In such a case, the documents are sequentially fed from the lowermost document of the document bundle set on the document table (stacker). Then, a pickup roller that can be lifted and lowered is provided below the placement portion, and the pickup roller enters an opening or a notch of the placement portion from below and contacts on the lowermost surface of the document bundle on the placement portion. The pressing roller (pressing member) is also provided so as to be storable below the placement portion, and the pressing roller enters the opening or the notch of the placement portion from below at the time of pressing and contacts on the lowermost surface of the document bundle on the placement portion.

Even in such a case, an effect similar to that of the present embodiment can be obtained.

The present invention is not limited to the present embodiment, and it is apparent that the present embodiment can be appropriately changed within the scope of the technical idea of the present invention in addition to what is suggested in the present embodiment. For example, the number, position, and shape of the constituent members are not limited to the present embodiment, and may be, for example, the number, position, and shape that are suitable for implementing the present invention.

In the present specification, the term “sheet” is defined as the document D set in the document feeder 3, which includes normal paper, all sheet-shaped members such as coated paper, label paper, an overhead projector (OHP) transparency sheet, a film, and a sheet formed with punch holes, and furthermore includes the sheet P fed in the manual sheet conveying device 110 serving as a sheet conveying device.

An aspect of the present invention may be, for example, a combination of Aspects 1 to 12 as described below.

### Aspect 1

In Aspect 1, a sheet conveying device that feeds a sheet in a predetermined feeding direction, includes a placement portion, a pickup roller, a feeding roller, a separation member, a pressing member, and a pressurization mechanism. The placement portion is a portion on which the sheet can be placed. The pickup roller contacts on a surface of the sheet placed on the placement portion and picks up the sheet in the feeding direction. The feeding roller is installed on a downstream side in the feeding direction with respect to the pickup roller and conveys the sheet picked up by the pickup roller in the feeding direction. The separation member forms a nip in which the sheet is conveyed by contacting on the feeding roller and prevents multiple sheets from being sent from the nip. The pressing member is installed on an upstream side in the feeding direction with respect to the pickup roller and can switch between a pressed state and a separated state with respect to the surface of the sheet placed on the placement portion. The pressurization mechanism adjusts a pressurization force of the pickup roller to the sheet placed on the placement portion to be reduced when the pressing member is in the pressed state as compared with when the pressing member is in the separated state.

### Aspect 2

In Aspect 2, the sheet conveying device according to Aspect 1, includes a pair of side fences for determining a position in a width direction orthogonal to the feeding direction with respect to the sheet placed on the placement portion. The pressing member is arranged at a central portion in the width direction. When a sheet whose position in the width direction cannot be determined by the pair of side fences is placed on the placement portion, the pressing member is brought into the pressed state manually or automatically. When the sheet

whose position in the width direction cannot be determined by the pair of side fences is not placed on the placement portion, the pressing member is brought into the separated state manually or automatically.

### Aspect 3

In Aspect 3, in the sheet conveying device according to Aspect 1 or 2, the pressurization mechanism is configured to reduce the pressurization force in conjunction with an operation in which the pressing member is switched from the separated state to the pressed state, and increase the pressurization force in conjunction with an operation in which the pressing member is switched from the pressed state to the separated state.

### Aspect 4

In Aspect 4, in the sheet conveying device according to Aspect 3, the pressurization mechanism includes a pressurization member, a slide member, and a biasing member. The pressurization member indirectly or directly pressurizes the pickup roller from above. The slide member changes a position of the pressurization member in a vertical direction by sliding movement. The biasing member biases the slide member in a positive direction in a sliding direction. The slide member slides in a direction opposite to the positive direction such that the pressurization member moves upward against the biasing force of the biasing member in conjunction with an operation in which the pressing member is switched from the separated state to the pressed state, and the slide member slides in the positive direction such that the pressurization member moves downward by the biasing force of the biasing member in conjunction with an operation in which the pressing member is switched from the pressed state to the separated state.

### Aspect 5

In Aspect 5, in the sheet conveying device according to any one of Aspects 1 to 4, in the separated state, the pressing member is stored at a storing position that does not interfere with setting of the sheet on the placement portion by an operator.

### Aspect 6

In Aspect 6, in the sheet conveying device according to any one of Aspects 1 to 5, in the pressed state, the pressing member includes a pressing roller that rotates together with conveyance of the sheet to be pressed in the feeding direction.

### Aspect 7

In Aspect 7, in the sheet conveying device according to Aspect 6, multiple pressing rollers is installed at an interval in the feeding direction.

### Aspect 8

In Aspect 8, the sheet conveying device according to any one of Aspects 1 to 7, includes a retention member that rotatably retains each of the pickup roller and the feeding roller, wherein the pressurization mechanism is configured to pressurize a side of the retention member closer to the pickup roller than to the feeding roller.

### Aspect 9

In Aspect 9, in the sheet conveying device according to any one of Aspects 1 to 8, the pressing member is arranged at a central portion in the width direction, and a central position in the width direction substantially matches with a central position in the width direction of each of the pickup roller, the feeding roller, and the separation member.

### Aspect 10

In Aspect 10, in the sheet conveying device according to any one of Aspects 1 to 9, a relationship of A≤B≤C is satisfied, where A is a conveyance load applied to the sheet by the pressing member in the pressed state, B is a conveying force when the pickup roller conveys the sheet when the pressing member is in the pressed state, and C is a conveying force when the pickup roller conveys the sheet when the pressing member is in the separated state.

### Aspect 11

In Aspect 11, a document feeder includes the sheet conveying device according to any one of Aspects 1 to 10, and a conveyance portion that conveys a document as a sheet placed on the placement portion on a downstream side of the feeding roller in a conveyance direction.

### Aspect 12

In Aspect 12, an image forming apparatus includes the sheet conveying device according to any one of Aspects 1 to 10.

### Aspect 13

In Aspect 13, a sheet conveying device includes a stacker, a pickup roller, a conveyor, a separator, a pressing member, and a pressure mechanism. The stacker stacks a sheet. The pickup roller contacts the sheet on the stacker, and picks up the sheet on the stacker in a conveyance direction. The conveyor is downstream from the pickup roller in the conveyance direction, to convey the sheet picked up by the pickup roller in the conveyance direction. The separator contacts the conveyor to form a nip to nip the sheet conveyed in the conveyance direction, and restricts a conveyance of multiple sheets including the sheet, including the sheet, by the nip in the conveyance direction. The pressing member is upstream from the pickup roller in the conveyance direction. The pressing member has a state switchable between a pressing state in which the pressing member presses the sheet on the stacker and a separated state in which the pressing member is separated from the sheet on the stacker. The pressure mechanism causes the pickup roller to apply a first pressure force to the sheet on the stacker when the pressing member is in the separated state, and causes the pickup roller to apply a second pressure force smaller than the first pressure force to the sheet on the stacker when the pressing member is in the pressing state.

### Aspect 14

In Aspect 14, the sheet conveying device according to Aspect 13 further includes a pair of side fences to adjust a position of the sheet on the stacker in a width direction orthogonal to the conveyance direction. The pressing member is at a center in the width direction. The pressing member is in the pressing state when the multiple sheets on the stacker are not aligned by the pair of side fences. The pressing member is in the separated state when the multiple sheets on the stacker are aligned by the pair of side fences.

### Aspect 15

In Aspect 15, in the sheet conveying device according to Aspect 13 or 14, the pressure mechanism decreases a pressure force of the pickup roller from the first pressure force to the second pressure force when the state of the pressing member is switched from the separated state to the pressing state, and increases the pressure force from the second pressure force to the first pressure force when the state of the pressing member is switched from the pressing state to the separated state.

### Aspect 16

In Aspect 16, in the sheet conveying device according to Aspect 15, the pressure mechanism includes a pressure pin, a slider, and a bias. The pressure pin pressurizes the pickup roller in a vertical direction. The slider is slidable in a sliding direction to change a position of the pressure pin in the vertical direction. The bias biases the slider in a positive direction of the sliding direction. The slider slides in a negative direction opposite to the positive direction of the sliding direction, to cause the pressure pin to move upward against the bias when the state of the pressing member is switched from the separated state to the pressing state. The slider slides in the positive direction of the sliding direction, to cause the pressure pin to move downward by the bias when the state of the pressing member is switched from the pressing state to the separated state.

### Aspect 17

In Aspect 17, in the sheet conveying device according to any one of Aspects 13 to 16, the pressing member is stored at a storing position outside an area above the stacker when the pressing member is in the separated state.

### Aspect 18

In Aspect 18, in the sheet conveying device according to any one of Aspects 13 to 17, the pressing member includes a pressing roller to be rotated, along with a conveyance of the sheet to be pressed in the conveyance direction when the pressing member is in the pressing state.

### Aspect 19

In Aspect 19, in the sheet conveying device according to Aspect 18, multiple pressing rollers including the pressing roller, at intervals in the conveyance direction.

### Aspect 20

In Aspect 20, the sheet conveying device according to any one of Aspects 13 to 19 further includes a retention member to rotatably retain the pickup roller and the conveyor. The pressure mechanism pressurizes the retention member at a portion closer to the pickup roller than to the conveyor.

### Aspect 21

In Aspect 21, in the sheet conveying device according to any one of Aspects 13 to 20, the pressing member is at a center in the width direction. A position of the center in the width direction of the pressing member substantially matches with a position of a center in the width direction of each of the pickup roller, the conveyor, and the separator.

### Aspect 22

In Aspect 22, in the sheet conveying device according to any one of Aspects 13 to 21, a relation of A≤B≤C is satisfied, where “A” represents a conveyance load applied to the sheet by the pressing member in the pressing state, “B” represents a conveyance force applied when the pickup roller conveys the sheet in the pressing state of the pressing member, and “C” represents a conveyance force applied when the pickup roller conveys the sheet in the separated state of the pressing member.

### Aspect 23

In Aspect 23, a document feeder includes the sheet conveying device that includes a stacker, a pickup roller, a conveyor, a separator, a pressing member, a pressure mechanism, and a conveyance portion. The stacker stacks a sheet. The pickup roller contacts the sheet on the stacker, and picks up the sheet on the stacker in a conveyance direction. The conveyor is downstream from the pickup roller in the conveyance direction, to convey the sheet picked up by the pickup roller in the conveyance direction. The separator contacts the conveyor to form a nip to nip the sheet conveyed in the conveyance direction, and restricts a conveyance of multiple sheets, including the sheet, by the nip in the conveyance direction. The pressing member is upstream from the pickup roller in the conveyance direction. The pressing member has a state switchable between a pressing state in which the pressing member presses the sheet on the stacker and a separated state in which the pressing member is separated from the sheet on the stacker. The pressure mechanism causes the pickup roller to apply a first pressure force to the sheet on the stacker when the pressing member is in the separated state, and causes the pickup roller to apply a second pressure force smaller than the first pressure force to the sheet on the stacker when the pressing member is in the pressing state. The conveyance portion conveys a document as the sheet on the stacker at a position downstream from the conveyor in the conveyance direction.

### Aspect 24

In Aspect 24, an image forming apparatus includes the sheet conveying device that includes a stacker, a pickup roller, a conveyor, a separator, a pressing member, and a pressure mechanism. The stacker stacks a sheet. The pickup roller contacts the sheet on the stacker, and picks up the sheet on the stacker in a conveyance direction. The conveyor is downstream from the pickup roller in the conveyance direction, to convey the sheet picked up by the pickup roller in the conveyance direction. The separator contacts the conveyor to form a nip to nip the sheet conveyed in the conveyance direction, and restricts a conveyance of multiple sheets, including the sheet, by the nip in the conveyance direction. The pressing member is upstream from the pickup roller in the conveyance direction. The pressing member has a state switchable between a pressing state in which the pressing member presses the sheet on the stacker and a separated state in which the pressing member is separated from the sheet on the stacker. The pressure mechanism causes the pickup roller to apply a first pressure force to the sheet on the stacker when the pressing member is in the separated state, and causes the pickup roller to apply a second pressure force smaller than the first pressure force to the sheet on the stacker when the pressing member is in the pressing state.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A sheet conveying device comprising:
a stacker to stack a sheet;
a pickup roller to:
contact the sheet on the stacker; and
pick up the sheet on the stacker;
a conveyor downstream from the pickup roller in a conveyance direction,
to convey the sheet picked up by the pickup roller in the conveyance direction;
a separator to:
contact the conveyor to form a nip to nip the sheet conveyed in the conveyance direction; and
restrict a conveyance of multiple sheets including the sheet, including the sheet, by the nip in the conveyance direction;
a pressing member upstream from the pickup roller in the conveyance direction, the pressing member having a state switchable between:
a pressing state in which the pressing member presses the sheet on the stacker; and
a separated state in which the pressing member is separated from the sheet on the stacker; and
a pressure mechanism to:
cause the pickup roller to apply a first pressure force to the sheet on the stacker when the pressing member is in the separated state; and
cause the pickup roller to apply a second pressure force smaller than the first pressure force to the sheet on the stacker when the pressing member is in the pressing state.

2. The sheet conveying device according to claim 1, further comprising a pair of side fences,
to adjust a position of the sheet on the stacker in a width direction orthogonal to the conveyance direction,
wherein the pressing member is at a center in the width direction,
the pressing member is in the pressing state when the multiple sheets on the stacker are not aligned by the pair of side fences, and
the pressing member is in the separated state when the multiple sheets on the stacker are aligned by the pair of side fences.

3. The sheet conveying device according to claim 1,
wherein the pressure mechanism:
decreases a pressure force of the pickup roller from the first pressure force to the second pressure force when the state of the pressing member is switched from the separated state to the pressing state; and
increases the pressure force from the second pressure force to the first pressure force when the state of the pressing member is switched from the pressing state to the separated state.

4. The sheet conveying device according to claim 3,
wherein the pressure mechanism includes:
a pressure pin to pressurize the pickup roller in a vertical direction;
a slider slidable in a sliding direction to change a position of the pressure pin in the vertical direction; and
a bias to bias the slider in a positive direction of the sliding direction, and
the slider slides in a negative direction opposite to the positive direction of the sliding direction,
to cause the pressure pin to move upward against the bias when the state of the pressing member is switched from the separated state to the pressing state, and
the slider slides in the positive direction of the sliding direction,
to cause the pressure pin to move downward by the bias when the state of the pressing member is switched from the pressing state to the separated state.

5. The sheet conveying device according to claim 1,
wherein the pressing member is stored at a storing position outside an area above the stacker when the pressing member is in the separated state.

6. The sheet conveying device according to claim 1,
wherein the pressing member includes a pressing roller to be rotated, along with a conveyance of the sheet to be pressed in the conveyance direction when the pressing member is in the pressing state.

7. The sheet conveying device according to claim 6,
wherein multiple pressing rollers including the pressing roller, at intervals in the conveyance direction.

8. The sheet conveying device according to claim 1, further comprising a retention member to rotatably retain the pickup roller and the conveyor,
wherein the pressure mechanism pressurizes the retention member at a portion closer to the pickup roller than to the conveyor.

9. The sheet conveying device according to claim 1,
wherein the pressing member is at a center in the width direction, and
a position of the center in the width direction of the pressing member substantially matches with a position of a center in the width direction of each of the pickup roller, the conveyor, and the separator.

10. The sheet conveying device according to claim 1,
wherein a relation of A≤B≤C is satisfied, where:
“A” represents a conveyance load applied to the sheet by the pressing member in the pressing state;
“B” represents a conveyance force applied when the pickup roller conveys the sheet in the pressing state of the pressing member; and
“C” represents a conveyance force applied when the pickup roller conveys the sheet in the separated state of the pressing member.

11. A document feeder comprising a sheet conveying device including:
a stacker to stack a sheet;
a pickup roller to:
contact the sheet on the stacker; and
pick up the sheet on the stacker in a conveyance direction;
a conveyor downstream from the pickup roller in the conveyance direction,
to convey the sheet picked up by the pickup roller in the conveyance direction;
a separator to:
contact the conveyor to form a nip to nip the sheet conveyed in the conveyance direction; and
restrict a conveyance of multiple sheets, including the sheet, by the nip in the conveyance direction;
a pressing member upstream from the pickup roller in the conveyance direction, the pressing member having a state switchable between:
a pressing state in which the pressing member presses the sheet on the stacker; and
a separated state in which the pressing member is separated from the sheet on the stacker;
a pressure mechanism to:
cause the pickup roller to apply a first pressure force to the sheet on the stacker when the pressing member is in the separated state; and
cause the pickup roller to apply a second pressure force smaller than the first pressure force to the sheet on the stacker when the pressing member is in the pressing state; and
a conveyance portion to convey a document as the sheet on the stacker at a position downstream from the conveyor in the conveyance direction.

12. An image forming apparatus comprising a sheet conveying device including:
a stacker to stack a sheet;
a pickup roller to:
contact the sheet on the stacker; and
pick up the sheet on the stacker in a conveyance direction;
a conveyor downstream from the pickup roller in the conveyance direction,
to convey the sheet picked up by the pickup roller in the conveyance direction;
a separator to:
contact the conveyor to form a nip to nip the sheet conveyed in the conveyance direction; and
restrict a conveyance of multiple sheets, including the sheet, by the nip in the conveyance direction;
a pressing member upstream from the pickup roller in the conveyance direction, the pressing member having a state switchable between:
a pressing state in which the pressing member presses the sheet on the stacker; and
a separated state in which the pressing member is separated from the sheet on the stacker; and
a pressure mechanism to:
cause the pickup roller to apply a first pressure force to the sheet on the stacker when the pressing member is in the separated state; and
cause the pickup roller to apply a second pressure force smaller than the first pressure force to the sheet on the stacker when the pressing member is in the pressing state.
